(19) United States
(12) Patent Application Publication
(10) Pub. No.: US 2006/0080169 A1
(43) Pub. Date: Apr. 13, 2006

(54) Fair scheduling of the display of personalized marketing content in a marketing subsystem of an e-commerce system

(75) Inventors: Lev Mirlas, Thornhill (CA); Danny Yiu, Markham (CA)

Correspondence Address: International Business Machines;Intellectual Property Law, 3039 Cornwallis Road, P.O. Box 12195, T-8/503, Research Triangle Park, NC, 27709, US

(73) Assignee: International Business Machines Corporation, Armonk, NY (US)

(21) Appl. No.: 10/964,058

(22) Filed: Oct. 13, 2004

(51) Int. Cl. G06Q 30/00

(52) U.S. Cl. 705/14

(57) ABSTRACT

A method, system and apparatus for fairly scheduling the display of personalized marketing messages in a marketing subsystem in an e-commerce system. A method of fairly scheduling the display of personalized marketing messages in a marketing subsystem of an e-commerce system can include allocating each individual space in a visual portion of a virtual store front to a corresponding individual marketing initiative according to a relative priority determined for the corresponding individual marketing initiative. The relative priority can be determined according to the equation RP=(BP/SP)*RS where RP is the relative priority, BP is a base priority, SP is a sum of all priorities for all marketing campaigns and RS is a number of remaining individual spaces to be allocated in the visual portion.

### BACKGROUND OF THE INVENTION

1. Statement of the Technical Field

The present invention relates to the operation of a marketing subsystem in an e-commerce system and more particularly to the display of personalized marketing content in a marketing subsystem in an e-commerce system.

2. Description of the Related Art

E-commerce systems have evolved to provide virtual storefronts whose operational capabilities far exceed those of the traditional, brick and mortar store. Whereas in the brick and mortar store, each of the sales, marketing, order fulfillment, inventory, and customer service functions remain the separate responsibilities of corresponding business roles, in a well-defined e-commerce system, each of the sales, marketing, order fulfillment, inventory and customer service can be integrated in a single computing system in a highly automated fashion. Consequently, a more optimal business operation can result in which data flows between different functional subsystems seamlessly to facilitate the daily conduct of business managed by the e-commerce system.

In the prototypical e-commerce system, an on-line catalog of available goods and/or services for sale can be established along with associated pricing. Customers can be provided with a store front user interface through which customers can browse the on-line catalog. When a customer desires to purchase a product or service, the customer can so indicate causing the addition of the selected product or service to an on-line shopping cart, though it is also known to bypass the shopping cart model in favor of direct purchase model. Notably, advanced forms of an e-commerce system can include a marketing subsystem which can manage the integration of a marketing campaign through the store front user interface.

Where a marketing subsystem manages the integration of a marketing campaign through a store front interface, a portion of the storefront interface can be dedicated to marketing messages such as audible or graphical product offers or promotions, or promotions relating to a specific portion of the virtual store. While some marketing subsystems incorporate only static marketing content in the store front user interface, other marketing subsystems permit the dynamic placement of marketing content in a designated area of the virtual store front. In some instances, marketing content rendered in the designated area can change with each invocation of a view of the virtual store front. In other instances, marketing content rendered in the designated area can change periodically within the same rendering of the view of the virtual store front.

Recent e-commerce system implementations incorporate marketing subsystems capable of accommodating multiple instances of personalized marketing content in a single reserved portion of a virtual store front. Personalized marketing content differs from ordinary content in that the personalized marketing content can be selected dynamically based upon end user centric rules. Typical rules address the actions of the end users when interacting with the e-commerce system, and known information regarding the end user such as past purchases, browsed portions of the virtual store, and demographic data, to name a few.

Importantly, because this type of e-commerce system can handle the concurrent display of different personalized marketing messages, multiple different marketing campaigns can be activated in a single, virtual store front. For instance, initiatives supporting both up-selling content for selected products and general awareness marketing type content can be provided in the same space. Moreover, multiple instances of content for each campaign can be dynamically provided in the same space. As such, some scheduling is required to determine which marketing messages to render in the space at any time. Generally, marketing subsystems utilize a randomization process based upon assigned priorities to determine which marketing messages to render in the single space.

Presently, marketing subsystems handle the concurrent display of different marketing messages for different campaigns at the granular level. Specifically, all possible content which can be rendered in the single space can be considered based upon priority. As a result, some content will never be displayed simply because the priority of other content can well exceed that of the excluded content. In the instance of a single marketing campaign (alternatively referred to as a marketing activity or marketing initiative), it is acceptable to exclude some marketing messages for lack of sufficient priority. In the case where multiple marketing campaigns are to be displayed concurrently in a single space in a user interface, however, it becomes possible that an entire marketing campaign can be excluded where the granular messages associated with the campaign lack sufficient priority over all other marketing messages associated with other, favored campaigns.

### SUMMARY OF THE INVENTION

The present invention addresses the deficiencies of the art in respect to the display of personalized marketing content in a marketing subsystem of an e-commerce system and provides a novel and non-obvious method, system and apparatus for fairly scheduling the display of personalized marketing messages in a marketing subsystem in an e-commerce system. A method of fairly scheduling the display of personalized marketing messages in a marketing subsystem of an e-commerce system can include allocating each individual space in a visual portion of a virtual store front to a corresponding individual marketing initiative according to a relative priority determined for the corresponding individual marketing initiative. The relative priority can be determined according to the equation RP=(BP/SP)*RS where RP is the relative priority, BP is a base priority, SP is a sum of all priorities for all marketing campaigns and RS is a number of remaining individual spaces to be allocated in the visual portion.

Subsequently, for each allocated individual space, a personalized marketing message utilized by a corresponding individual marketing initiative can be assigned for display in the individual space. In a preferred aspect of the invention, the method also can include the steps of, for each individual marketing initiative, determining whether a number of allocated individual spaces exceeds a number of personalized marketing messages utilized by a corresponding individual marketing initiative. Consequently, excess ones of the allocated individual spaces can be re-assigned to other individual marketing initiatives.

The assigning step can include, for each allocated individual space, determining random priorities of display for each of the personalized marketing messages utilized by the corresponding individual marketing initiative and selecting an individual one of the personalized marketing messages for display in the individual space based upon the random priorities. As such, subsequently, a different individual one of the personalized marketing messages can be selected for display in the individual space based upon the random priorities. Alternatively, the assigning step can include, for each allocated individual space, determining personalization information for an interacting end user and selecting an individual one of the personalized marketing messages utilized by the corresponding individual marketing initiative for display in the individual space based upon the personalization information. Again, subsequently a different individual one of the personalized marketing messages can be selected for display in the individual space based upon the personalization information.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of an e-commerce system having a marketing subsystem which has been configured in accordance with the present invention;

FIG. 2 is a block diagram illustrating a scheduling process for displaying personalized marketing content in the marketing subsystem of FIG. 1; and,

FIGS. 3A and 3B, taken together, are a flow chart illustrating a process for scheduling the display of personalized marketing content in the marketing subsystem of FIG. 1.

### DETAILED DESCRIPTION OF THE PREFERRED EMBODIMENTS

The present invention is a method, system and apparatus for the fair scheduling of personalized marketing messages in a marketing subsystem of an e-commerce system. In accordance with the present invention, one or more message display spaces in a designated portion of a virtual store front can be assigned to corresponding individual marketing campaigns, otherwise referred to as marketing initiatives or marketing activities. To the extent that any one initiative has been assigned more display spaces than available marketing messages associated with the initiative, the excess spaces can be re-assigned to other initiatives requiring additional display spaces. Subsequently, one or more marketing messages for each of the marketing campaigns can be prioritized for rendering in the assigned message display spaces corresponding the respective marketing campaigns.

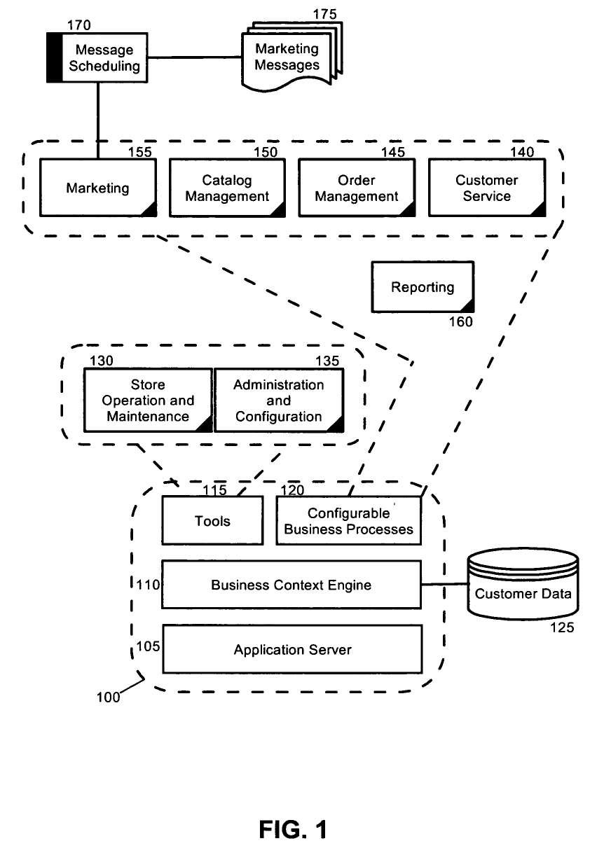

In more particular illustration of the inventive embodiments, FIG. 1 is a schematic illustration of an e-commerce system 100 having a marketing subsystem 155 which has been configured in accordance with the present invention. The e-commerce system 100 can be configured both to host a virtual store and also to process interactions with the virtual store through a virtual store front. To that end, the e-commerce system 100 can include an application server 105 arranged to process application logic and to route requests to and responses from the application logic in the course of hosting and process interactions in and with the virtual store. Specifically, the application server 105 can support the construction, deployment and management of network applications including Internet and intranet Web applications defining the virtual store.

A business context engine 110 can be coupled to the application server 105 which can facilitate electronic commerce through the application logic. The business context engine 110 can include an integration component for integrating the application logic with other applications by way of a messaging facility and a corresponding programming model. The business context engine 110 further can include analytics logic for analyzing the end user usage of the virtual store. The business context engine 110 yet further can include personalization logic for tailoring the virtual store front according to a number of criteria, including how a customer is segmented or grouped, segment information, shopping cart contents, and purchase history, to name a few.

The business context engine 110 also can include globalization context governing how the virtual store behaves according to the locale of an interacting end user. The context can include both language and currency information as matched to the language and currency supported by the virtual store. Finally, the business context engine 110 can include roles, relationships and agreements governing customer access to various aspects of the virtual store, such as what products a customer can purchase, the prices to be paid for a product, and what payment methods can be accepted from a customer. Configurable business processes, contract based commerce, granular terms and conditions, member management, configurable workflow, and role-based entitlements further can be included as part of the business context engine 110.

A set of tools 115 can be included with the e-commerce system 100. The tools 115 can include a virtual store operation and maintenance component 130 facilitating the operation and maintenance of virtual stores defined with the e-commerce system 100. The set of tools 115 also can include an administration and configuration component 135. The administration and configuration component 135 can permit the configuration of the e-commerce system 100 itself. Optionally, the set of tools 115 can include an application development environment (not shown) for developing the application logic of the e-commerce system 100.

A set of configurable business processes 120 can provide the foundation for the e-commerce system. The set of configurable business processes can include a customer service subsystem 140, an order management subsystem 145, a catalog management subsystem 150 and a marketing subsystem. Optionally, the set of configurable business processes can include a reporting subsystem 160. Notably, the marketing subsystem 155 can include logic for allocating a visual portion of the virtual store front for displaying one or more marketing messages 175 based upon personalization information reflected in the customer data 125. Moreover, the ordering and placement of the marketing messages 175 in the allocated portion of the virtual store front can be managed by a message scheduling processor 170.

In particular, the message scheduling processor 170 can assign selected individual marketing initiatives to corresponding individual portions of the allocated portion of the virtual store. The selection of the individual marketing initiatives can be based, for example, on a prioritization of different marketing initiatives. Once the marketing initiatives have been assigned to the corresponding individual portions of the allocated portion of the virtual store, marketing messages 175 utilized by the marketing initiatives can be selected for rendering in the respective individual portions of the allocated portion of the virtual store. Consequently, the marketing messages 175 can be selected for display more fairly than would be the case with a direct assignment of the individual portions of the allocated portion of the virtual store front to marketing messages 175.

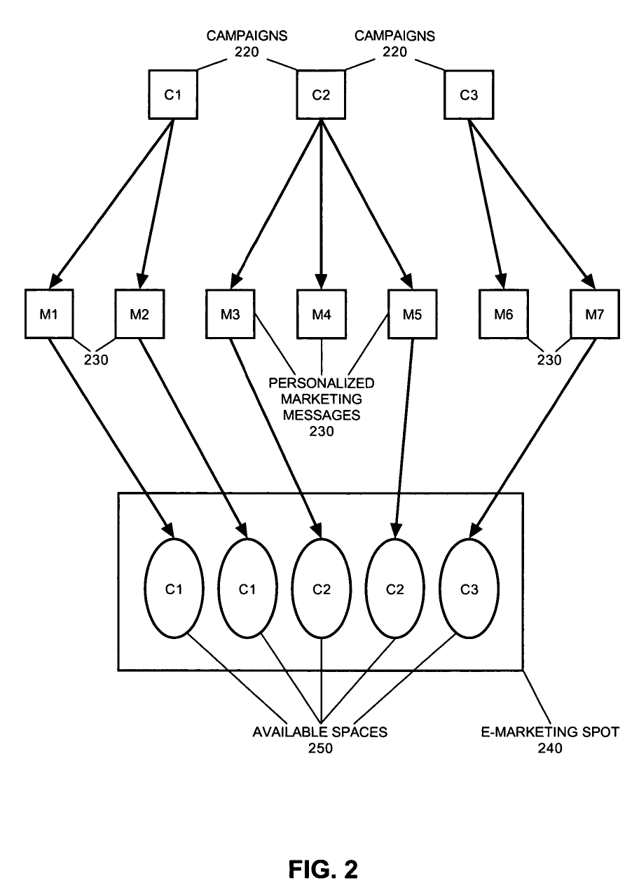

To further explain the fair allocation of the individual portions of the allocated portion of the virtual store front, FIG. 2 is a block diagram illustrating a scheduling process for displaying personalized marketing content in the virtual store front produced by the marketing subsystem of FIG. 1. As shown in FIG. 2, one or more marketing initiatives 220, otherwise referred to as activities or campaigns, can utilize one or more personalized marketing messages 230 as part of the initiative. Exemplary initiatives 220 can include product up-selling, general product awareness, catalog awareness and the like.

A visual portion 240 of the virtual store front, referred to herein as an e-marketing spot, can have one or more available spaces 250 which can be assigned to individual ones of the campaigns 220. In this regard, any one of the campaigns 220 can be assigned to one or more of the available spaces 250 based upon a pre-specified criteria, or a manual selection. Optionally, where more of the available spaces 250 have been assigned to a campaign 220 then would be necessary to display all of the utilized personalized marketing messages 230, excess assigned ones of the available spaces 250 can be released for re-assignment to others of the campaigns 220. In any event, once an available space 250 has been allocated to a specific one of the campaigns 220, the personalized marketing messages 230 utilized by the specific one of the campaigns 220 can be ordered for rendering in the available space 250.

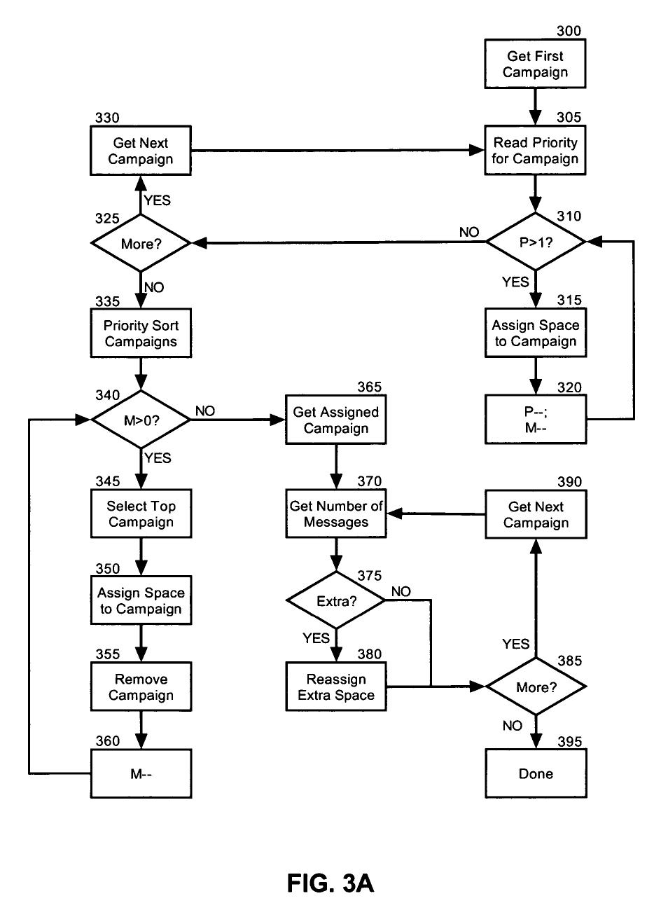

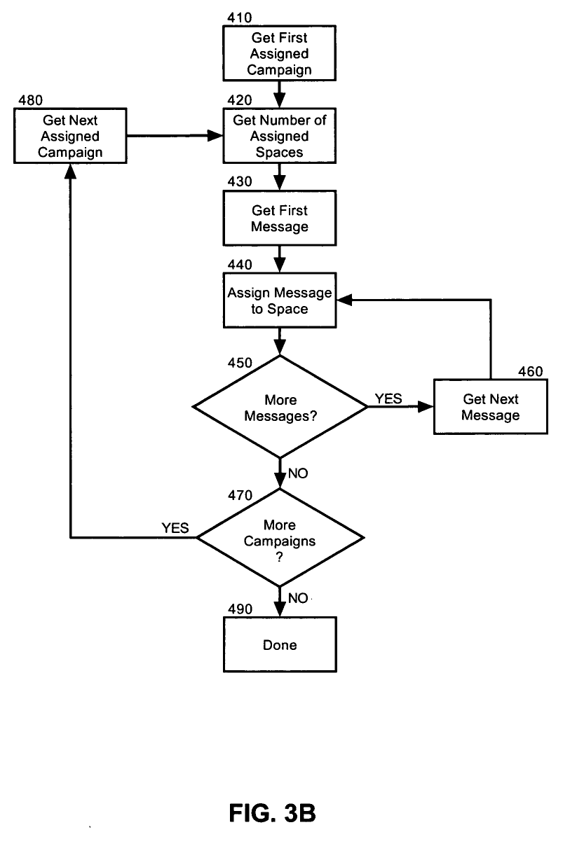

In further illustration of the assignment process, FIGS. 3A and 3B, taken together, are a flow chart illustrating a preferred albeit non-exclusive process for scheduling the display of personalized marketing content in the marketing subsystem of FIG. 1. Beginning in block 300, a first campaign can be retrieved for consideration and block 305, a relative priority associated with the campaign can be determined. The relative priority can be defined as the base priority of the campaign over the sum of all campaign priorities by the number of spaces remaining in the visual portion of the virtual store front. [P=(Base Priority/Sum of Priorities)*Remaining Spaces].

In decision block 310, it can be determined if the relative priority exceeds unity. If so, in block 315, a space in the visual portion can be assigned to the campaign and in block 320 the relative priority and the number of spaces remaining to be allocated can be decremented. Subsequently, in decision block 310, once again it can be determined if the relative priority exceeds unity. This process can repeat until the relative priority no longer exceeds unity. At that time, in decision block 325 it can be determined whether other campaigns remain to be considered. If so, in block 330 a next campaign can be retrieved and the process can repeat through decision block 310. Otherwise, the process can continue through block 335.

In block 335, the remaining campaigns which have not yet been assigned space can be sorted according to relative priorities. Subsequently, in decision block 340 it can be determined whether any space remains to be allocated. If so, in block 345, the highest prioritized campaign can be selected and in block 350, a space can be assigned to the selected campaign. Subsequently, in block 355 the selected campaign can be removed from the sorted list the number of available spaces remaining to be allocated can be decremented in block 360 and the process can repeat in decision block 340. When no further spaces remain to be assigned, in block 365 the first assigned campaign can be selected and a number of personalized marketing messages utilized by the selected campaign can be determined in block 370.

If, in decision block 375, it is determined that more space has been assigned to the campaign than required to display all of the utilized marketing messages, in block 380, the excess space can be re-assigned to other campaigns in the sorted list which have not yet been assigned required space. In this way, no space will go wasted. Otherwise, in decision block 385, if more campaigns remain to be processed, in block 390 a next campaign can be selected and the process can repeat through block 370. When all assigned campaigns have been considered, the process of FIG. 3A can end in block 395.

Turning now to FIG. 3B, when all spaces have been assigned to specified marketing campaigns, the personalized marketing messages for the specified marketing campaigns can be selected for display in the allocated spaces of the visual portion of the virtual store front. Specifically, in block 410, a first assigned campaign can be selected for processing. Subsequently, in block 420, a number of assigned spaces associated with the selected campaign can be determined and, based upon the, determined number of spaces, in blocks 430 through 460, the spaces can be populated with corresponding personalized marketing messages utilized by the selected campaign. This process can repeat in decision block 470 and block 480 until no more assigned campaigns remain to be considered, subsequent to which the process can end in block 490.

Importantly, the process described herein introduces a degree of fairness in rendering personalized marketing messages through a marketing subsystem not presently known. In fact, at present, spaces within a visual portion are allocated directly to personalized marketing messages without regard to the importance or priority of a marketing campaign utilizing the personalized marketing messages. Consequently, to the extent that one campaign utilizes personalized marketing messages which enjoy a higher priority than those of a different campaign, the different campaign can be unfairly excluded from display in the e-marketing spot. Therefore, the present invention ensures the consideration of the priority of different campaigns in according a degree of fairness to the scheduling process.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A method of fairly scheduling the display of personalized marketing messages in a marketing subsystem of an e-commerce system, the method comprising the steps of:
allocating each individual space in a visual portion of a virtual store front to a corresponding individual marketing initiative according to a relative priority determined for said corresponding individual marketing initiative; and,
for each allocated individual space, assigning a personalized marketing message utilized by a corresponding individual marketing initiative for display in said individual space.

2. The method of claim 1, further comprising the steps of:
for each individual marketing initiative, determining whether a number of allocated individual spaces exceeds a number of personalized marketing messages utilized by a corresponding individual marketing initiative; and,
re-assigning excess ones of said allocated individual spaces to other individual marketing initiatives.

3. The method of claim 1, further comprising the step of computing said relative priority according to the equation RP=(BP/SP)*RS where RP is said relative priority, BP is a base priority, SP is a sum of all priorities for all marketing campaigns and RS is a number of remaining individual spaces to be allocated in said visual portion.

4. The method of claim 1, wherein said assigning step comprises the steps of, for each allocated individual space, determining random priorities of display for each of said personalized marketing messages utilized by said corresponding individual marketing initiative and selecting an individual one of said personalized marketing messages for display in said individual space based upon said random priorities.

5. The method of claim 6, further comprising the step of subsequently selecting a different individual one of said personalized marketing messages for display in said individual space based upon said random priorities.

6. The method of claim 1, wherein said assigning step comprises the steps of, for each allocated individual space, determining personalization information for an interacting end user and selecting an individual one of said personalized marketing messages utilized by said corresponding individual marketing initiative for display in said individual space based upon said personalization information.

7. The method of claim 6, further comprising the step of subsequently selecting a different individual one of said personalized marketing messages for display in said individual space based upon said personalization information.

8. A system for fairly scheduling the display of personalized marketing messages, the system comprising:
an e-commerce system enabled to manage a virtual store accepting interactions through a virtual store front;
a marketing subsystem disposed in said e-commerce system; and,
a scheduling processor configured to allocate individual spaces in an e-marketing spot in the virtual store front for use by corresponding marketing initiatives and to schedule the display of personalized marketing messages utilized by said corresponding marketing initiatives in said allocated individual spaces in said e-marketing spot.

9. The system of claim 8, wherein said scheduling processor comprises logic both for determining for each individual marketing initiative whether a number of allocated individual spaces exceeds a number of personalized marketing messages utilized by a corresponding individual marketing initiative and also for re-assigning excess ones of said allocated individual spaces to other individual marketing initiatives.

10. A machine readable storage having stored thereon a computer program for fairly scheduling the display of personalized marketing messages in a marketing subsystem of an e-commerce system, the computer program comprising a routine set of instructions which when executed by a machine causes the machine to perform the steps of:
allocating each individual space in a visual portion of a virtual store front to a corresponding individual marketing initiative according to a relative priority determined for said corresponding individual marketing initiative; and,
for each allocated individual space, assigning a personalized marketing message utilized by a corresponding individual marketing initiative for display in said individual space.

11. The machine readable storage of claim 10, further comprising additional instructions for causing the machine to further perform the steps of:
for each individual marketing initiative, determining whether a number of allocated individual spaces exceeds a number of personalized marketing messages utilized by a corresponding individual marketing initiative; and,
re-assigning excess ones of said allocated individual spaces to other individual marketing initiatives.

12. The machine readable storage of claim 10, further comprising additional instructions for causing the machine to further perform the step of computing said relative priority according to the equation RP=(BP/SP)*RS where RP is said relative priority, BP is a base priority, SP is a sum of all priorities for all marketing campaigns and RS is a number of remaining individual spaces to be allocated in said visual portion.

13. The machine readable storage of claim 10, wherein said assigning step comprises the steps of, for each allocated individual space, determining random priorities of display for each of said personalized marketing messages utilized by said corresponding individual marketing initiative and selecting an individual one of said personalized marketing messages for display in said individual space based upon said random priorities.

14. The machine readable storage of claim 13, further comprising additional instructions for causing the machine to further perform the step of subsequently selecting a different individual one of said personalized marketing messages for display in said individual space based upon said random priorities.

15. The machine readable storage of claim 10, wherein said assigning step comprises the steps of, for each allocated individual space, determining personalization information for an interacting end user and selecting an individual one of said personalized marketing messages utilized by said corresponding individual marketing initiative for display in said individual space based upon said personalization information.

16. The machine readable storage of claim 15, further comprising additional instructions for causing the machine to further perform the step of subsequently selecting a different individual one of said personalized marketing messages for display in said individual space based upon said personalization information.
